(19) United States
(12) Patent Application Publication
(10) Pub. No.: US 2026/0115697 A1
(43) Pub. Date: Apr. 30, 2026

(54) METHOD OF SYNTHESIZING COPPER FERRITE NANOPARTICLES USING METAL CANS

(71) Applicant: KING SAUD UNIVERSITY, RIYADH (SA)

(72) Inventors: SEHAM SOLIMAN ALTERARY, RIYADH (SA); EMAN ISMAIL MOHAMED ALI, RIYADH (SA)

(21) Appl. No.: 18/933,818

(22) Filed: Oct. 31, 2024

(51) Int. Cl. B01J 23/745; B01J 23/00; B01J 35/33; B01J 35/39; B01J 35/45; B01J 37/00; B01J 37/02; B01J 37/03; B01J 37/06; B01J 37/08; C02F 1/32; C02F 1/72; C02F 101/30

(52) U.S. Cl. CPC B01J 23/745; B01J 23/005; B01J 35/33; B01J 35/39; B01J 35/45; B01J 37/009; B01J 37/0236; B01J 37/031; B01J 37/06; B01J 37/08; C02F 1/32; C02F 1/725; C02F 2101/308; C02F 2305/08; C02F 2305/10

(57) ABSTRACT

The present disclosure relates to a method of making CuFe₂O₄ nanoparticles from metal cans. The method includes cutting the metal can into small pieces, adding concentrated nitric acid to the pieces to obtain an iron nitrate solution, and adding an aqueous sodium hydroxide solution to the iron nitrate solution to provide a precipitate. The precipitate can be centrifuged and dissolved with HNO₃ to obtain an iron nitrate solution. The iron nitrate solution can be mixed with copper nitrates to obtain a mixture. Aqueous NaOH solution can be added to the mixture to obtain an aqueous precipitate including the CuFe₂O₄ nanoparticles.

### BACKGROUND

### 1. Field

The disclosure of the present patent application relates to a method for producing nanoparticles and, particularly, to a method of making copper ferrite nanoparticles using metal cans.

### 2. Description of the Related Art

Synthetic dyes are used in various industries including textile processing, food production, and the pharmaceutical sector. Approximately 80% of the dye-containing wastewater produced are often released untreated into waterways or used directly for irrigation, causing detrimental impacts on human health and ecosystems.

Untreated synthetic dyes released into aquatic environments reduce the light available for photosynthesis by primary producers, with consequential impacts for the whole food chain. In addition, dyes are also directly harmful to plants, animals and humans, with human health implications including increasing allergy and cancer risk.

Many tin-coated cans sit in landfills and/or are a discarded as litter worldwide. Metal is recyclable and can be recycled for a variety of uses, thereby, reducing the buildup of metal in landfills and in some instances reducing the need for mining additional metal.

Thus, a method of synthesizing copper ferrite nanoparticles using metal cans is desired.

### SUMMARY

The present disclosure involves a method for synthesizing copper ferrite (CuFe₂O₄) nanoparticles using metal cans, e.g., tin-coated metal cans. According to an embodiment of the present teachings, the method can include cutting tin-coated metal cans, e.g., cans used for storing tuna fish or “tuna cans,” into pieces, dissolving the pieces in concentrated H₂SO₄ to remove the tin layer from the metal pieces to provide tin-free metal pieces, dissolving the tin-free metal pieces in concentrated nitric acid (HNO₃) to obtain an iron nitrate solution, diluting the iron nitrate solution to provide a diluted iron nitrate solution, filtrating the diluted iron nitrate solution, adding NaOH to the filtrated solution to provide an alkaline solution (a pH of 10 is reached), centrifuging the alkaline solution to provide a precipitate, adding concentrated HNO₃ to the precipitate to dissolve the precipitate and provide an iron nitrate solution, mixing the iron nitrate solution with aqueous copper nitrate (in a 2:1 molar ratio) to provide a mixture; adding an aqueous solution of NaOH (dropwise) to the mixture to provide an alkaline mixture (pH 10) including a precipitate of magnetic nanoparticles. In an embodiment, the precipitate can be centrifuged and washed to provide a purified precipitate. The precipitate can then be dried and annealed to provide CuFe₂O₄ nanoparticles spinel CuFe₂O₄ nanoparticles in powder form. The CuFe₂O₄ nanoparticles can have a diameter ranging from about 17 nm to about 31 nm.

The present disclosure also relates to a method of degrading water-polluting dyes in sunlight using the CuFe₂O₄ nanoparticles prepared according to the methods disclosed herein. The water-polluting dyes may include methylene blue.

These and other features of the present subject matter will become readily apparent upon further review of the following specification.

### BRIEF DESCRIPTION OF THE DRAWINGS

FIG. 1 shows the EDX spectrum of the utilized tin-plated tuna alloy.

FIG. 2 shows the XRD analysis for the synthesized CuFe₂O₄ nanoparticles according to the present disclosure.

FIG. 3 shows the transmission electron microscope (TEM) images of CuFe₂O₄ nanoparticles according to the present disclosure.

FIG. 4 shows the scanning electron microscope (SEM) images of the CuFe₂O₄ nanoparticles according to the present disclosure.

FIG. 5 shows graph showing the FT-IR spectra of the synthesized CuFe₂O₄ nanoparticles.

FIG. 6 shows the photo-degradation of methylene blue by the synthesized copper ferrite nanoparticles under UV-light irradiation.

FIG. 7 shows a graph of the degradation efficiency of the CuFe₂O₄ nanoparticles under sunlight irradiation with Methylene Blue dye.

### DETAILED DESCRIPTION OF THE PREFERRED EMBODIMENTS

The following definitions are provided for the purpose of understanding the present subject matter and for construing the appended patent claims.

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

As described herein, pure CuFe₂O₄ nanoparticles can be prepared by using metal waste as an iron source instead of purchasing iron nitrate. Thus, the present method provides a simple, sustainable method to produce commonly used chemicals, namely metal ferrites, by recycling tin-plated metal cans. Since metals are non-renewable natural resources and can be recycled over and over again without the material losing quality, it is of great importance to recycle these commonly used cans.

The present methods can provide copper ferrite nanoparticles that exhibit excellent photochemical reactivity. The nanoparticles may efficiently degrade toxic water-polluting dyes in the presence of sunlight. The present method of producing copper ferrite nanoparticles using recycled tin-plated cans can be a valuable addition to water treatment.

The present method includes obtaining tin-coated cans, e.g., cans used to package tuna. In an embodiment, the tin-coated cans include tin-coated iron cans. In an embodiment, the iron comprises ferrous iron. The method can include removing tin from the tin-coated cans, e.g., by using concentrated H₂SO₄, to obtain ferrous metal pieces. In various implementations, the metal pieces can be washed, dried, and cut into small pieces prior to removing the tin. Concentrated nitric acid may be added to the small pieces to obtain an iron nitrate solution. The method can further include diluting the iron nitrate solution with water to obtain a 100 mL iron nitrate solution. An aqueous sodium hydroxide solution can be added dropwise to the 100 mL iron nitrate solution to obtain an aqueous precipitate with a pH of 10.

The method may further include settling the aqueous precipitate at room temperature. In some implementations, settling may last for at least about 1 hour. In other embodiments, the settling may last for about 2 hours. The method may further include washing the precipitate with distilled water to remove residues and centrifuging the precipitate. After centrifuging, the precipitate may be dissolved by adding 30 mL HNO₃ to obtain a pure iron nitrate solution. The resulting precipitate may include spinel CuFe₂O₄. The method may include adding copper nitrates to the iron nitrate solution to obtain a mixture. In various embodiments, the copper nitrate solution may include about 2 g copper nitrate dissolved in about 50 mL deionized water. The copper nitrates may be added to the iron nitrate solution in a 2:1 molar ratio. The mixture can be stirred. Then, aqueous NaOH solution may be added to the mixture, e.g., dropwise, to obtain an aqueous precipitate of magnetic nanoparticles. In various embodiments, sodium hydroxide may be added dropwise into the mixture until a pH of 10 is achieved.

The magnetic nanoparticles may be centrifuged and washed, then dried to obtain a brown powder. Drying the magnetic nanoparticles may be done at a temperature of about 60° C., for at least 24 hours. The method brown powder may be annealed at a temperature of about at least 850° C. The brown powder may be annealed for at least about 3 hours.

In various implementations, the CuFe₂O₄ nanoparticles may be black. In some implementations, the CuFe₂O₄ the nanoparticles may have an average size of about 24.3 nm, at least 24.3 nm, or 24.3 nm.

The present matter also relates to a method of degrading water-polluting dyes in water by contacting the CuFe₂O₄ nanoparticles with the water in the presence of sunlight. The CuFe₂O₄ nanoparticles may be prepared according to the method described herein. In various implementations, the water-polluting dyes may comprise methylene blue.

The present subject matter relates to a method of making spinel CuFe₂O₄ nanoparticles using tin coated cans. The method may include providing an iron can coated in tin and removing the tin by dissolving the tin in H₂SO₄. The method may further include cutting the iron can into pieces and dissolving the pieces in nitric acid to obtain an iron nitrate solution. The iron nitrate solution can be mixed with an aqueous copper nitrate solution to obtain spinel CuFe₂O₄ nanoparticles through co-precipitation. The method may further include centrifuging the spinel CuFe₂O₄ nanoparticles. The method may also include washing the spinel CuFe₂O₄ nanoparticles with water and ethanol. Then the method may include drying and calcining the spinel CuFe₂O₄ nanoparticles and obtaining CuFe₂O₄ nanoparticles.

In various implementations, the aqueous NaOH solution may have a concentration of 1.5 M.

In some implementations, the iron nitrate solution and copper nitrates can be mixed in a molar ratio of 2:1.

In some embodiments, the CuFe₂O₄ nanoparticles may be black.

In a further embodiment, the CuFe₂O₄ nanoparticles may have an average particle size of about 20 nm to about 30 nm, e.g., about 24.3 nm.

The present subject matter may include a method of degrading water-polluting dyes in sunlight using the CuFe₂O₄ nanoparticles prepared according to the method described herein.

In another embodiment, the water-polluting dyes can include methylene blue. In further implementations, other types of dyes may be removed using the nanoparticles as described herein.

The following examples relate to various methods of manufacturing the nanoparticles and application of the same, as described herein.

### Example 1

### Dissolving Tin-Plated Metal Cans

Tin-plated cans, made of ferrous metal and a thin layer of tin, were obtained. The tin layer was removed from the ferrous metal surface and the metal alloy was immersed in concentrated H₂SO₄ for 10 minutes. Then, this metal piece (4 g) was washed with distilled water, dried, and cut into small pieces. Then, 5 mL of concentrated HNO₃ was added to the metal pieces in a fume hood until the reaction started. Once the metal pieces began to etch, another 25 mL of HNO₃ was slowly added until the metal was completely etched. This resulted in the formation of a liquid brown solution, which was then transferred to Whatman filter paper and diluted with deionized water until the volume reached 100 mL of the iron nitrate solution obtained.

### Example 2

### Preparation of Copper Ferrite Nanoparticles

Subsequently, a 1.5 M aqueous sodium hydroxide solution was added dropwise to the obtained ferric nitrate solution up to a pH˜10. The obtained aqueous precipitate was allowed to settle at room temperature for 1 hour, then washed three times with distilled water to remove residues. Then, the obtained precipitate was centrifuged and water was completely drained from the centrifuged precipitate to remove other impurities or residues. Then, 30 mL of HNO₃ was added to the filtered precipitate until it was completely dissolved and returned to its liquid form to obtain a pure iron nitrate solution. The iron nitrate solution and copper nitrates were mixed in a 2:1 molar ratio by adding the 100 mL iron solution to 2 g copper nitrates in 50 mL deionized water to form a mixture. With vigorous stirring, 1.5 M aqueous sodium hydroxide solution was added dropwise for 1 hour to the mixture until pH˜10 was reached. The obtained aqueous precipitate of magnetic NPs was allowed to settle at room temperature for 2 hours, then centrifuged, washed with ethanol and deionized water, and dried at 60° C. for 24 hours. The resulting brown powder was then annealed at 850° C. for 3 hours. The resulting black powder contained CuFe₂O₄ nanoparticles.

### Example 3

### Characterization of the Synthesized Copper Ferrite Nanoparticles and Tin-Plated can

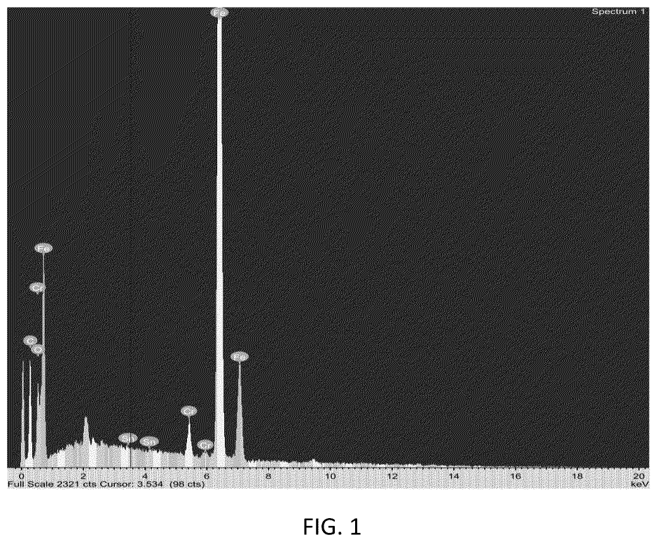

Energy dispersive X-ray spectroscopy (EDX, JEOL, JSM6390) was performed to determine the elemental composition of the tin-plated alloy used. FIG. 1 shows the EDX elemental mapping of the tinned alloy after removal of the tin layer. The results presented in Table 1 describe the elemental composition of the alloy in weight percent. It shows that the can waste includes iron, carbon, oxygen, chromium and tin. The CuFe₂O₄ nanoparticles formed in Example 2 were characterized using various instruments.

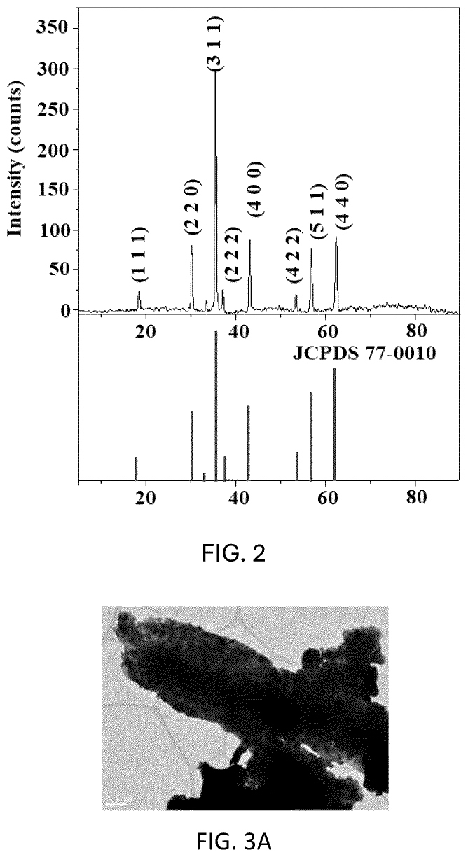

The Powder X-ray diffraction (XRD) analysis performed using Bruker D8 ADVANCE to the synthesized copper ferrites nanoparticles is depicted in FIG. 2. The XRD analysis indicates major diffraction peaks at 2θ=18.4°, 30.2°, 35.6°, 37.3°, 43.3°, 53.7°, 57.2° and 62.9°, corresponding to the following Miller indices (1 1 1), (2 2 0), (3 1 1), (2 2 2), (4 0 0), (4 2 2), (5 1 1), and (4 4 0), respectively, JCPDS 77-0010. This pattern shows the cubic spinel structure of the CuFe₂O₄ nanopowder. The most intense reflection peak (311) was observed at 35.4°, which is the characteristic peak of the spinel phase. Thus, the result shows that all of the samples have a pure single-phase cubic structure. The average crystallite size (D, nm) of the synthesized CuFe₂O₄ NPs was calculated using Scherrer's formula: D=0.9λ/β cos θ(4), where λ is the wavelength of the X-ray source in nm, β is the peak width at half maximum in radians, θ is the diffraction angle, and D is the crystallite size in nm. Using the Scherrer formula, the calculated crystallite size was determined to be 24.3±5 nm.

The image shows how a large number of small, spherical particle aggregates form micrometric clusters. The diameters of the smaller fractions are similar in all samples, with an average size of 26 to 30 nm, which is consistent with the results obtained from XRD measurements.

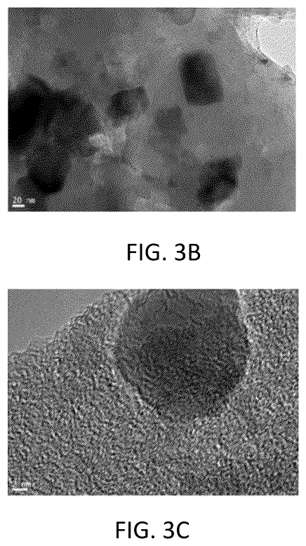

The more detailed morphology of the synthesized copper ferrite nanoparticles was studied using a high-resolution transmission electron microscope (HR-TEM) (JEM-2100, JEOL) at different length scales. FIGS. 3A, 3B, and 3C are TEM micrographs showing that the synthesized CuFe₂O₄ nanoparticles have a hemispherical shape, with small particle agglomerations in the form of clusters in random shapes.

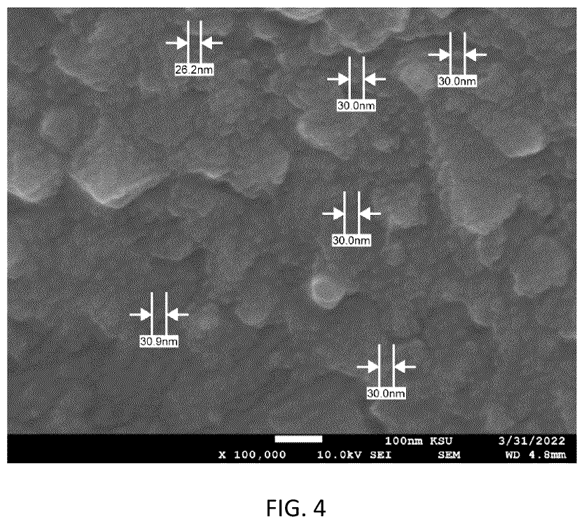

The particle size and the morphology of the synthesized CuFe₂O₄ were studied using a field emission scanning electron microscope (FE-SEM) equipped with a microscope (JEOL, JSM6390), as shown in FIG. 4.

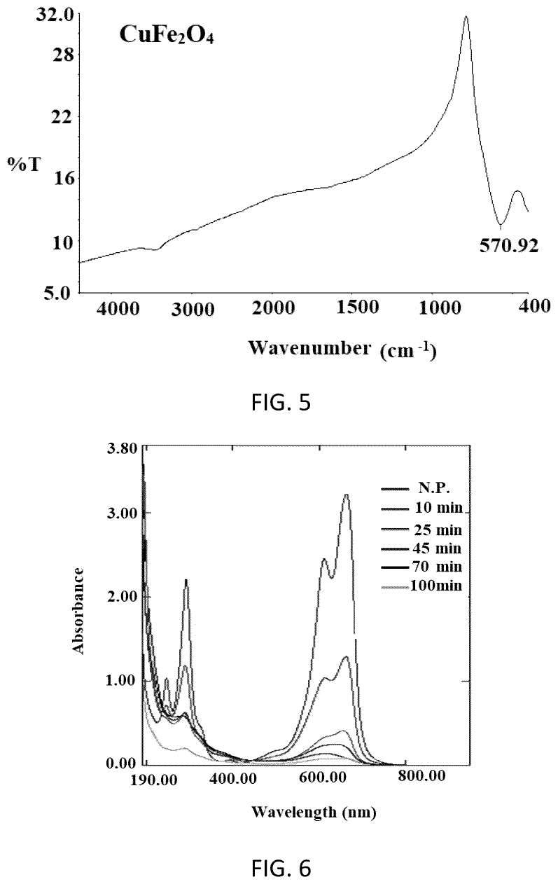

Fourier transform infrared (FT-IR) spectroscopy was performed to confirm the successful preparation of the spinel copper ferrite nanocomposite from 4000 to 400 cm⁻¹, as shown in FIG. 5. Generally, the metal oxide vibrations occur below 1000 cm⁻¹. In the spectrum, an absorption band, observed in the range of 570 cm⁻¹, was assigned to intrinsic stretching vibration of the metals at the tetrahedral site (A), and the band observed at 400 cm⁻¹, was assigned to octahedral (B) metal stretching which confirms the formation of spinel ferrite material.

### Example 4

### Photocatalytic Measurements

Photocatalytic activity of the as-synthesized CuFe₂O₄ nanoparticles was measured by performing batch experiments under sunlight irradiation using methylene blue dye. In a typical batch adsorption experiment, 0.05 g of CuFe₂O₄ nano-adsorbent was suspended in 7 ml of MB dye solution using a specific initial concentration (C0=100 mg L⁻¹) at 25° C. temperature. Optical absorption spectra were determined for a range of sunlight exposure durations, using a UV/Vis spectrophotometer. The dye degradation rate was monitored by recording the dye absorption intensity at the maximum wavelength FIG. 6. The dye degradation efficiency (DE %) was determined utilizing the equation:

$$DE \% = ( {A}_{0} - A ) / {A}_{0} \times 100$$

where; A₀ (mg L−1) and A (mg L−1) are the initial dye concentration and concentration of the dye solution at time t of the adsorption process.

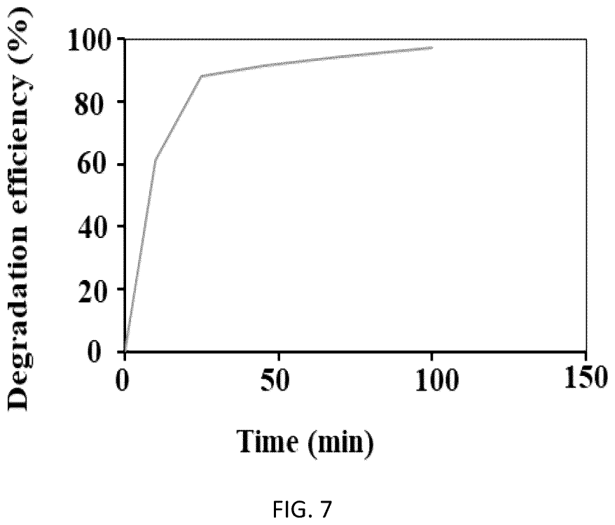

The copper ferrite nanoparticles produced by the method described herein, demonstrated high photocatalytic activity under sunlight exposure. Dye removal was about 99% after only 100 minutes of sunlight exposure (FIG. 7).

These results can be attributed to two main reasons: a) the expected low energy bandwidth of copper ferrite nanoparticles, and b) the very small particle size of the synthesized copper ferrite nanoparticles, which is in the range of 17 nm to 31 nm, leading to an increase in the number of active sites and thus the number of photons absorbed by the catalyst.

It is to be understood that embodiments of the method of synthesizing copper ferrite nanoparticles using metal cans as described herein are not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method of making spinel CuFe₂O₄ nanoparticles from metal cans, the method comprising:
obtaining a metal can;
cutting the metal can to obtain ferrous metal pieces;
adding concentrated nitric acid to the ferrous metal pieces to obtain an iron nitrate solution;
diluting the iron nitrate solution with water to obtain a diluted iron nitrate solution;
adding an aqueous sodium hydroxide solution to the diluted iron nitrate solution to provide a precipitate;
washing the precipitate with distilled water to remove residues;
centrifuging the precipitate;
dissolving the centrifuged precipitate to obtain a pure iron nitrate solution;
adding copper nitrates to the pure iron nitrate solution in a molar ratio of 2:1 copper ions:iron ions to obtain a mixture;
stirring and adding aqueous NaOH solution to the mixture to obtain a slurry of magnetic nanoparticles;
centrifuging and washing the magnetic nanoparticles in the slurry;
drying magnetic nanoparticles to obtain a powder; and
annealing the powder at a temperature of about 850° C. for about 3 hours to provide pure single-phase spinel CuFe₂O₄ nanoparticles.

2. The method of claim 1, further comprising removing tin from the metal can.

3. The method of claim 2, wherein removing the tin comprises immersing the metal can in concentrated H₂SO₄.

4. The method of claim 1, wherein the powder is brown.

5. (canceled)

6. The method of claim 1, wherein the aqueous NaOH solution has a concentration of 1.5 M.

7. (canceled)

8. The method of claim 1, wherein drying the magnetic nanoparticles is performed at a temperature of about 60° C. for at least about 24 hours.

9. (canceled)

10. The method of claim 1, wherein the spinel CuFe₂O₄ nanoparticles are black.

11. The method of claim 1, wherein the spinel CuFe₂O₄ nanoparticles have an average size of about 20 nm to about 30 nm.

12-20. (canceled)
